(19) United States
(12) Patent Application Publication
(10) Pub. No.: US 2008/0142428 A1
(43) Pub. Date: Jun. 19, 2008

(54) Evaporation Reservoir

(75) Inventors: Brigitte Louise Maria Baggen, Monchengladbach (DE); Paul Edmund Raith, Haan (DE); Dick Velings, Dusseldorf (DE); Henricus Joannes Maria Van De Ven, Arnhem (NL); Gabriele Beate Wittmann, Wuppertal (DE)

Correspondence Address: OLIFF & BERRIDGE, PLC, P.O. BOX 320850, ALEXANDRIA, VA, 22320-4850, US

(73) Assignee: Sympatex Technologies GMBH, Unterohring (DE)

(21) Appl. No.: 11/883,059

(22) PCT Filed: Feb. 21, 2006
(86) PCT No.: PCT/EP2006/001533

§ 371 Date: Jul. 26, 2007

(30) Foreign Application Priority Data
Feb. 24, 2005 (DE) 102005008864.3

(51) Int. Cl. B01D 63/00

(52) U.S. Cl. 210/321.6

(57) ABSTRACT

Evaporation reservoir for recovering purified water, with an interior for holding water to be purified, the interior enclosed by walls that are watertight and joined to each other in a watertight manner, at least one wall consisting at least partially of a laminate that has a textile fabric and a watertight, non-porous, and water-vapor permeable membrane, and with an opening for filling the interior, characterized in that at least one edge of the laminate is joined to an edge of the adjacent wall via a tensile-resistant, watertight tape in such a manner that the tensile-resistant, watertight tape is joined on the one hand to the textile fabric and on the other hand watertight to the membrane and extends beyond the edge of the laminate, and the watertight joint with the edge of the adjacent wall is formed exclusively by the part of the watertight tape that extends beyond the laminate.

The water evaporating from the reservoir is condensed at a condensation surface arranged above the reservoir and the condensed water is collected.

The invention relates to an evaporation reservoir for recovering purified water, with an interior for holding water to be purified, the interior enclosed by walls that are watertight and joined together in a watertight manner, at least one wall consisting at least partially of a laminate that has a textile fabric and a watertight, non-porous, and water-vapor permeable membrane, and with an opening for filling the interior and a water purification system containing at least one of such a evaporation reservoir.

Evaporation reservoirs are known from U.S. Pat. No. 5,595,662 and WO 00/28807, for example. These evaporation reservoirs are used for water purification, wherein during use water is evaporated via a membrane that delimits a reservoir filled with water to be purified, the water again condensing via a condensation surface and collected. The water to be purified can be sea water or polluted water. To obtain water of drinking quality, it is recommended to employ non-porous but water-vapor permeable membranes as far as possible. Hydrophilic membranes are preferably suited for this purpose. Suitable materials used for such membranes are preferably hydrophilic polyurethanes, polyetheresters, and polyetheramides. Since such membranes are generally very thin, it is recommended to reinforce the membranes with textile fabrics such as wovens, nonwovens, or knits, and it is advantageous to laminate the membrane to the textile fabric.

According to U.S. Pat. No. 5,595,662, the membranes have the form of a bag and are suspended in a support structure, that at the same time serves as a condensation surface, and filled with water to be purified. This design is very complex. Moreover, the suspended arrangement of the membrane bags makes it possible to produce only bags of small dimensions, since otherwise the water to be purified is so heavy that the membrane bag leaks or even bursts. Furthermore, the bags must be emptied at regular intervals and freed of the residues, so that this type of apparatus is suitable only for short-term use.

The object of the present invention is to provide an evaporation reservoir that is easy to produce and does not have the aforementioned disadvantages. Preferably, the reservoir should also be producible in larger dimensions. In particular, the reservoir should also be suitable for use at varying locations.

The object of the invention is achieved by an evaporation reservoir for recovering purified water, with an interior for holding water to be purified, the interior enclosed by walls that are watertight and joined to each other in a watertight manner, at least one wall consisting at least partially of a laminate that has a textile fabric and a watertight, non-porous, and water-vapor permeable membrane, and with an opening for filling the interior, characterized in that at least one edge of the laminate is joined to an edge of the adjacent wall via a tensile-resistant, watertight tape in such a manner that the tensile-resistant, watertight tape is joined on the one hand to the textile fabric and on the other hand watertight to the membrane and extends beyond the edge of the laminate, and only the part of the watertight tape that extends beyond the laminate is joined watertight to the edge of the adjacent wall.

A watertight joint provided by the tensile-resistant, watertight tape to an adjacent edge can be produced by friction, such as by pressing the elements together that are to be sealed. This can be implemented by clamping mechanisms known per se, or by gluing, where the adhesives used should also seal the joint area.

In this case, the edge of the adjacent wall is either the edge of a stable part of the reservoir, the edge of a watertight, tensile-resistant film, or also a tensile-resistant, watertight tape that in turn is joined to the edge of the adjacent laminate in a tensile-resistant and watertight manner.

With large reservoirs in particular, it is possible to join most of the edges of the walls watertight by sealing them from the inside. However, at least the last joint must be made from the outside, since it is not possible to work reliably through the generally very small filler opening. At least one edge of the walls of the evaporation reservoir of the invention has a watertight joint that can be made from the outside. This ensures that the force absorption under load occurs via the textile fabric and the additional tensile-resistant, watertight tape and thus relieves the sensitive membrane. At the same time, it is ensured that a watertight joint can be produced via the membrane and watertight tape.

In the evaporation reservoir of the invention, it has proven especially advantageous if the tensile-resistant, watertight tape is comprised of inner and outer tapes, where the inner tape is joined to the membrane and the outer tape to the textile fabric of the laminate, the inner and outer tapes extend beyond the edge of the laminate, and the two extending parts of the inner and outer tapes are joined together.

The outer tape absorbs the tensile forces from the textile fabric, while the inner tape ensures a good seal.

A further advantageous embodiment of the evaporation reservoir of the invention is characterized in that the edge of the laminate is folded over to the outside to form a fold area, the tensile-resistant, watertight tape covering the fold area in such a way that a first part of the tape is joined to the textile fabric, a center part joined watertight to the membrane of the fold area, and an additional part extends beyond the fold area.

A watertight joint between a textile fabric and another material is always problematical, since the sealing material generally penetrates the textile fabric only with difficulty and also frayed fiber ends of the textile fabric frequently draw water by capillary action through the sealing area as such. Folding over the lower edge causes the membrane to now face outward. Since the tensile-resistant tape is joined not only to the membrane in the fold area but also to the textile fabric further inside, on the one hand a frictional joint is achieved between the tensile-resistant tape and the textile fabric of the laminate, and on the other hand a watertight joint between the membrane and the tensile-resistant tape. The extending part of the tensile-resistant tape can then be used to generate a watertight and frictional joint with the edge of the adjacent wall.

In particular, the evaporation reservoir of the invention is characterized in that all walls consist of laminates, each of which has a textile fabric and a watertight, non-porous, water-vapor permeable membrane, where at least one edge of a laminate is joined watertight to the corresponding edge of a second laminate such that the edge of the one laminate is joined to a first tensile-resistant, watertight tape and the edge of the second laminate is joined to a second tensile-resistant, watertight tape such that the respective tensile-resistant, watertight tape is joined on the one hand to the textile fabric and on the other hand watertight to the membrane of the respective laminate and extends beyond the edge of the respective laminate, the watertight joint of the two laminates is produced exclusively via a watertight joint of the two extending parts of the first and second tensile-resistant, watertight tapes, and all additional edges of the laminate are joined watertight in the same way to the adjacent edges of the additional laminate or are joined in a known manner and sealed watertight from the inside.

A particularly simple way to join laminates together in a known manner is to sew the two laminates together, a sealing tape being glued watertight from the inside to the area in which the two laminates are sewn to each other. Since in the evaporation reservoir of the invention the membrane of the laminate is arranged facing the interior, the sealing of the seam area is particularly effective using sealing tape. These sealing tapes are also known from the field of watertight and water-vapor permeable clothing and serve thereby to seal the seams present in the clothing. They consist of a watertight tape to which a generally thermoplastic adhesive has been applied. This tape can be applied to the intended areas with an iron, for example, where the heat of the iron initiates the melting of the thermoplastic adhesive, which joins to the membrane in a watertight manner.

As a rule, this known method of joining is used on all edges that can be reached without great difficulty and without damaging the membrane of the laminate. At least the last open edge of the evaporation reservoir is then joined to the adjacent edge in a watertight manner from the outside via the aforementioned tensile-resistant, watertight tapes.

In particular when purifying salt water or contaminated water, it is practical to provide an additional opening in the evaporation reservoir of the invention to drain the water from the interior.

By doing so, the concentration of unwanted substances in the interior of the evaporation reservoir can be kept at a low level by constant feeding and draining of the water to be purified, so that the evaporation reservoir of the invention can also be used over a long period of time without interruption.

To achieve the feeding and draining of the water to be purified without leakage, the evaporation reservoir of the invention is characterized in particular in that the opening for filling the interior and/or draining the water is provided in the laminate, and that at least from the inside an inner annular disc whose opening is smaller than the opening in the laminate is joined in a watertight manner to the membrane of the laminate.

In this case, it has proven especially advantageous if the evaporation reservoir of the invention is provided from the outside with an additional, outer annular disc, which is joined in an outer area to the laminate and in an inner area to the inner annular disc.

Conventional tubing connections can then be made to the annular discs that have been joined together.

An evaporation reservoir that has proven especially advantageous consists of two laminates forming the walls of the interior, each laminate having a textile fabric and a watertight, non-porous, and water-vapor permeable membrane, whereby the two laminates are laid together with the membrane sides facing each other and joined on at least one of the side edges via tensile-resistant, watertight tapes in the manner previously described, the two laminates possibly being sewn to each other at other side edges via seams, where the seams are sealed watertight from the inside using a watertight seam-sealing tape, and each side edge is joined watertight via either the tensile-resistant, watertight tapes or a seam with seam-sealing tape.

The invention relates also to a water purification system containing at least one of the described evaporation reservoir.

The invention will be described in more detail with reference to the figures.

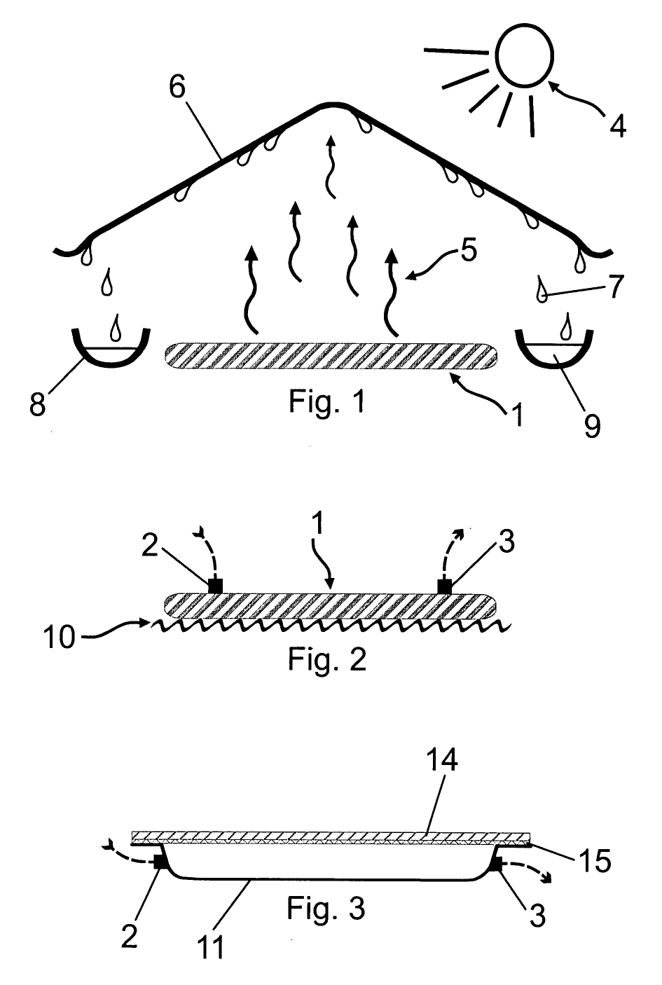

FIG. 1 shows a schematic representation of a water purification system using the evaporation reservoir of the invention.

FIG. 2 shows an embodiment of the evaporation reservoir of the invention that consists only of laminates.

FIG. 3 shows a further embodiment of the evaporation reservoir of the invention with a stable tub covered by a laminate.

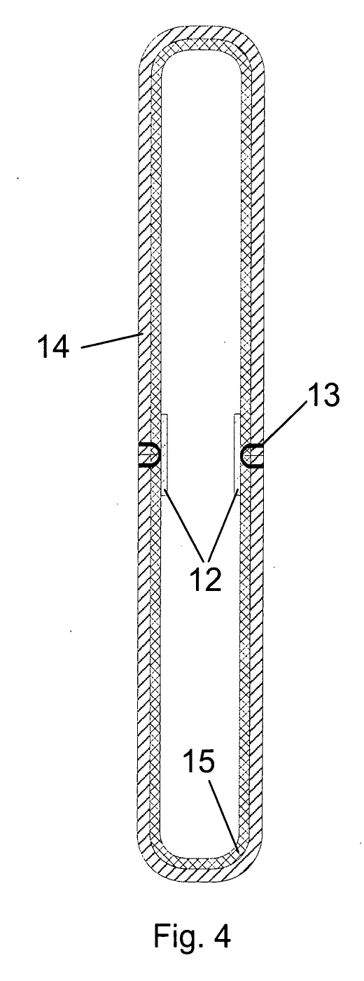

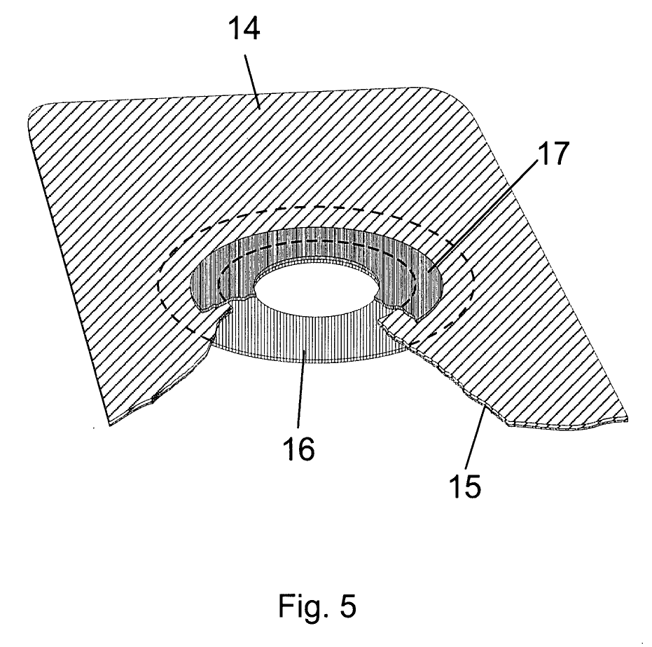

FIG. 4 shows an evaporation reservoir of the invention in cross-section with sealing of the seam from the inside.

FIG. 5 shows a schematic representation of the sealing of an opening.

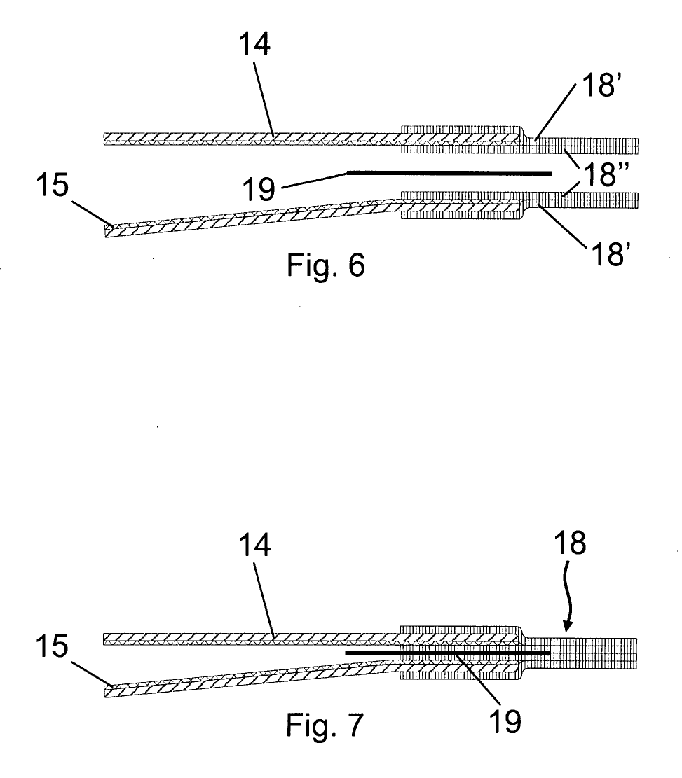

FIGS. 6 and 7 show a schematic representation of the procedure for producing a watertight joint between two laminate edges using two tensile-resistant tapes in each case.

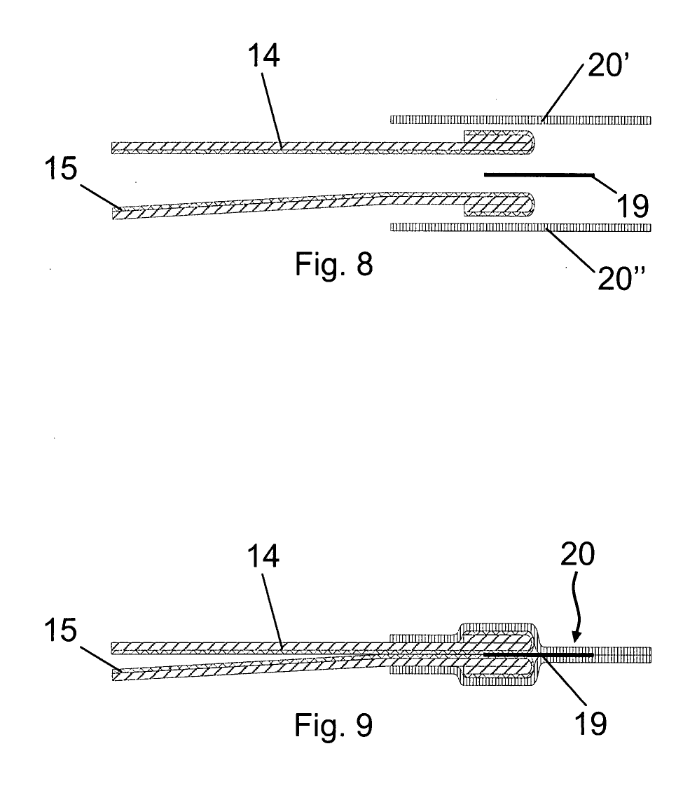

FIGS. 8 and 9 show a schematic representation of the procedure for producing a watertight joint between two laminate edges in which the edge is folded over to the outside.

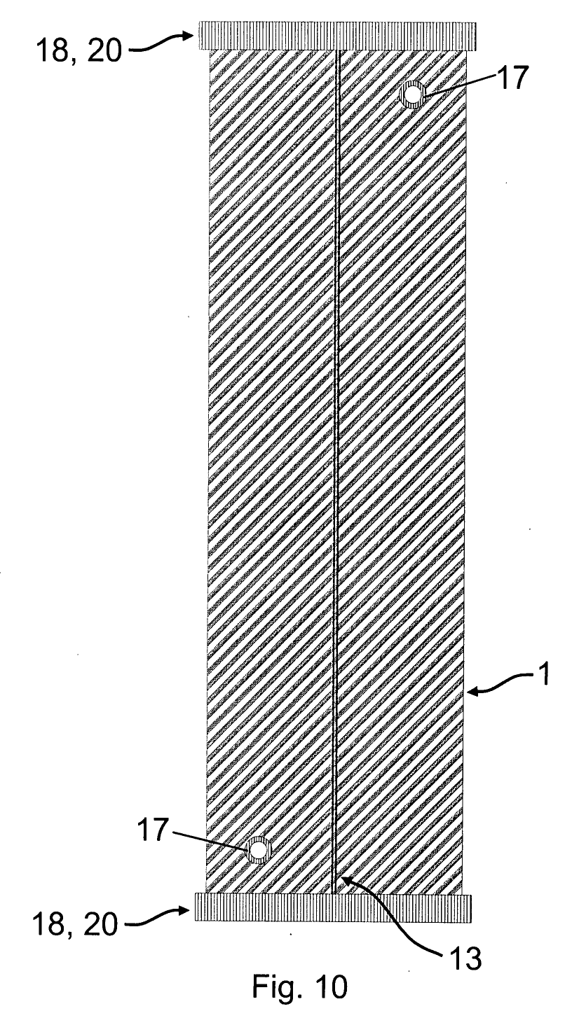

FIG. 10 shows a schematic representation of an evaporation reservoir of the invention consisting of two laminates.

According to FIG. 1, an evaporation reservoir 1 of the invention, filled with water to be purified, is arranged under a roof 6, which is penetrable by rays of the sun 4. At least one part of the evaporation reservoir 1 is formed by a laminate (not shown) that contains a watertight, non-porous, and water-vapor permeable membrane. The membrane, which is in contact with the water to be purified, emits, due to the water-vapor permeability, water vapor 5, which then condenses at roof 6 and falls in drops 7 into a channel 8, in which the resulting purified water 9 is collected.

The evaporation reservoir 1 can, as depicted in FIG. 2, be provided with an inlet 2 and an outlet 3 for the water to be purified. To the extent that the underside of the evaporation reservoir 1 also has a laminate with a watertight, non-porous, and water-vapor permeable membrane, the reservoir 1 can be laid directly on the ground to moisten the earth, as described in WO 01/10192, for example. To achieve improved ventilation and avoid fungus or algae growth, however, it is practical to arrange a spacer 10 between the evaporation reservoir and the ground. Suitable spacers are spacer fabrics or mats with a high pore volume, for example. It is also possible to lay the spacer and evaporation reservoir in a collection tub to enable collection of the condensed water that falls.

In one embodiment, the lower part of the evaporation reservoir is formed as a watertight tub 11 with inlet 2 and outlet 3, as shown in FIG. 3, the tub covered by a laminate 14/15. The laminate 14/15 consists of a textile fabric 14 to which a watertight, non-porous, and water-vapor permeable membrane 15 has been laminated. The watertight joint between tub 11 and laminate 14/15 is produced via a tensile-resistant, watertight tape, which for clarity is not shown in FIG. 3. The arrangement and securing of the tape can be performed in the manner shown in FIG. 6 or 8, where the respective part of the tape 18 that extends beyond laminate 14/15 is joined watertight to the edge of the tub.

In particular when the evaporation reservoir of the invention is to be used for rapidly recovering purified water, such as in areas stricken by a catastrophe, it is advantageous if the evaporation reservoir 1 is composed solely of laminates 14/15. In this case, large-area evaporation reservoirs can be produced by joining two laminates of the same width over their entire length via seams 13 on both sides, where the seams 13 are provided from the inside with a respective sealing tape 12 and the tapes are joined watertight to membrane 15 and thereby seal seam 13 watertight (see FIG. 4). For this purpose, special devices can be used that simultaneously produce seam 13 and apply the sealing tape 12.

To the extent that one or more inlets or outlets are provided in the laminate, it is recommended that these be implemented, in accordance with the invention, via two annular discs 16 and 17. In this case, annular disc 16 is joined watertight to membrane 15 from the inside, while annular disc 17 is glued to textile fabric 14 from the outside. Both annular discs 16 and 17 have the same inner opening, which is smaller than the opening in the laminate. The parts of the annular discs 16 and 17 that extend beyond the laminate 14/15 toward the inner opening are joined to each other, preferably watertight. These two annular discs 16 and 17 are made of a watertight and tensile-resistant material. Tubing connections known per se, via which the water to be purified can be introduced or drained, can be inserted in the inner opening of the joined annular discs 16 and 17.

FIGS. 6 and 7 depict how two laminates 14/15 can be joined to each other in a watertight manner at their edge in accordance with the invention. In this case, the two laminates are joined by a respective inner tape 18″ and outer tape 18′. The inner tape 18″ is joined to membrane 15 watertight, preferably by gluing, such that the tape extends beyond the edge of the laminate. The outer tape 18′ is joined to the textile fabric 14, preferably by gluing, also in such a way that the outer tape 18′ extends beyond the edge of the laminate. The two extending areas of tapes 18′ and 18″ are likewise joined together, likewise preferably by gluing. This procedure is performed for both the lower laminate 14/15 and the upper laminate 14/15. Prior to joining the upper and lower tapes together, an intermediate element 19 is inserted, to which the material that is to join the upper and lower tapes does not adhere. In this manner, it is ensured that the watertight joint between the upper and lower laminates 14/15 is produced only over the part of the tapes that extends beyond the laminate. The load produced on the watertight joint of the two laminates when the evaporation reservoir is in use is thereby transmitted from the tape to the textile fabric, so that the sensitive membrane is not subjected to high tensile forces that could tear the membrane, thus compromising the watertightness of the evaporation reservoir. To ensure the absorption of the forces produced by the load occurring during operation, the tapes 18′ and 18″ are tensile-resistant. The structure of the edges, joined together watertight, of the upper and lower laminates is shown in FIG. 7.

The joint of the upper laminate with an outer tape 18′ and inner tape 18″, as depicted in FIG. 6, the tapes being glued together in the area extending beyond the laminate, is also suitable, for example, for producing the watertight joint between tub 11 and laminate 14/15 in the embodiment shown in FIG. 3 by joining the part of the tape extending beyond the laminate watertight to the edge of the tub.

A further method for joining two laminates in a watertight manner according to the invention is depicted in FIGS. 8 and 9. In this embodiment, the edges of the two laminates 14/15 to be joined together are each folded over to the outside, so that the membrane 15 faces outward in the fold area. A tape 20′ is joined to the upper laminate and a tape 20″ to the lower laminate in such a manner that a first part of the tape is joined to the textile fabric 14, a second, center part is joined watertight to membrane 15, and a third part extends beyond the fold area. The parts of tapes 20′ and 20″ extending beyond the fold area are joined together watertight, and use of intermediate element 19 avoids the joining together of membranes 15 of the upper and lower laminates in order to provide effective protection against tearing of the membrane under load. The load acting on the joint area is transferred efficiently into the textile fabric via the tensile-resistant tapes 20′ and 20″, so that the membrane is spared this load.

An evaporation reservoir of the invention sealed at two opposite ends as depicted in FIGS. 6 and 7 or FIGS. 8 and 9 is shown in FIG. 10. In this case, two laminates are joined together via seams 13, the seams 13 being sealed watertight from the inside as shown in FIG. 4. The two ends of the hose-like evaporation reservoir thus produced are sealed using the technique of the invention as shown in FIGS. 6 and 7 or FIGS. 8 and 9 (denoted in FIG. 10 by 18,20 in each case). At one end, however, the one laminate can be provided with a tensile-resistant tape according to FIG. 6 and the opposite laminate with a tensile-resistant tape according to FIG. 8, and these two tapes can be joined together watertight in the area extending beyond the laminate. Furthermore, the evaporation reservoir has an inlet and an outlet, the outer annular discs 17 of which are visible.

1. Evaporation reservoir for recovering purified water, with an interior for holding water to be purified, the interior enclosed by walls that are watertight and joined to each other in a watertight manner, at least one wall consisting at least partially of a laminate that has a textile fabric and a watertight, non-porous, and water-vapor permeable membrane, and with an opening for filling the interior, wherein at least one edge of the laminate is joined to an edge of the adjacent wall via a tensile-resistant, watertight tape in such a manner that the tensile-resistant, watertight tape is joined on the one hand to the textile fabric and on the other hand watertight to the membrane and extends beyond the edge of the laminate, and the watertight joint with the edge of the adjacent wall is formed exclusively by the part of the watertight tape that extends beyond the laminate.

2. Evaporation reservoir according to claim 1, wherein the tensile-resistant, watertight tape is comprised of inner and outer tapes, wherein the inner tape is joined to the membrane and the outer tape to the textile fabric of the laminate, the inner and outer tapes extend beyond the edge of the laminate, and the two extending parts of the inner and outer tapes are joined together.

3. Evaporation reservoir according to claim 1, wherein the edge of the laminate is folded over to the outside to form a fold area, the tensile-resistant, watertight tape covering the fold area in such a way that a first part of the tape is joined to the textile fabric, a center part is joined watertight to the membrane of the fold area, and an additional part extends beyond the fold area.

4. Evaporation reservoir according to claim 1, wherein all walls consist of laminates, each of which has a textile fabric and a watertight, non-porous, water-vapor permeable membrane, where at least one edge of a laminate is joined watertight to the corresponding edge of a second laminate such that the edge of the one laminate is joined to a first tensile-resistant, watertight tape and the edge of the second laminate is joined to a second tensile-resistant, watertight tape such that the respective tensile-resistant, watertight tape is joined on the one hand to the textile fabric and on the other hand watertight to the membrane of the respective laminate and extends beyond the edge of the respective laminate, the watertight joint of the two laminates is produced exclusively by a watertight joint of the two extending parts of the first and second tensile-resistant, watertight tapes, and all additional edges of the laminate are joined watertight in the same way to the adjacent edges of the additional laminate or are joined in another manner and sealed watertight from the inside.

5. Evaporation reservoir according to claim 1, wherein a further opening is provided for draining the water contained in the interior.

6. Evaporation reservoir according to claim 1, wherein the opening for filling the interior and/or draining the water is provided in the laminate and that at least from the inside an inner annular disc whose opening is smaller than the opening in the laminate is joined in a watertight manner to the membrane of the laminate.

7. Evaporation reservoir according to claim 6, wherein from the outside an additional, outer annular disc is provided that is joined in an outer area to the laminate and in an inner area to the inner annular disc.

8. Evaporation reservoir according to claim 1, wherein it consists of two laminates forming the walls of the interior, each laminate having a textile fabric and a watertight, non-porous, and water-vapor permeable membrane, that the two laminates are laid together with the membrane sides facing each other, where at least one edge of a laminate is joined watertight to the corresponding edge of a second laminate such that the edge of the one laminate is joined to a first tensile-resistant, watertight tape and the edge of the second laminate is joined to a second tensile-resistant, watertight tape such that the respective tensile-resistant, watertight tape is joined on the one hand to the textile fabric (14) and on the other hand watertight to the membrane of the respective laminate and extends beyond the edge of the respective laminate, the watertight joint of the two laminates is produced exclusively by a watertight joint of the two extending parts of the first and second tensile-resistant, watertight tapes, and all additional edges of the laminate are joined watertight in the same way to the adjacent edges of the additional laminate or are joined in another manner and sealed watertight from the inside, the two laminates possibly being sewn to each other at other side edges via seams, where the seams are sealed watertight from the inside using a watertight seam-sealing tape, and each side edge is joined watertight via either the tensile-resistant, watertight tapes or a seam with seam-sealing tape.

9. Water purification system containing at least one evaporation reservoir according to claims 1.
